(19) United States
(12) Patent Application Publication
(10) Pub. No.: US 2018/0033254 A1
(43) Pub. Date: Feb. 1, 2018

(54) TABLE GAME WITH COLOR CODED GAME PIECES

(71) Applicant: Yocha Dehe Wintun Nation, Brooks, CA (US)

(72) Inventors: Ray Patterson, Brooks, CA (US); William Harland, Brooks, CA (US)

(21) Appl. No.: 15/726,889

(22) Filed: Oct. 6, 2017

Related U.S. Application Data
(63) Continuation of application No. 14/845,614, filed on Sep. 4, 2015.
(60) Provisional application No. 62/046,605, filed on Sep. 5, 2014.

(51) Int. Cl. G07F 17/34; A63F 1/06; G07F 17/32

(52) U.S. Cl. CPC G07F 17/34; A63F 1/067; G07F 17/3293; A63F 2003/00164

(57) ABSTRACT

A method for playing a game on a game surface. The method includes mixing a predetermined set of playing cards, placing each of the cards in the set face down into respective color coded areas on the game surface, and determining one or more colors appearing face up on a plurality of color coded game pieces based on a roll of the plurality of color coded game pieces on the game surface. The method further includes determining a result of the roll by revealing a subset of the set of cards in the plurality of color coded areas based on the one or more colors appearing face up on the plurality of color coded game pieces.

### CROSS-REFERENCE TO RELATED APPLICATIONS

This application is a continuation of U.S. patent application Ser. No. 14/845,614 filed Sep. 4, 2015, which claims the benefit of the filing date of U.S. Provisional Application 62/046,605 entitled “Table Game With Color Coded Game Pieces,” filed on Sep. 5, 2014, as does the present application. These prior applications are incorporated herein by reference in their entireties to the extent permitted by law.

### TECHNICAL FIELD

The field of the invention is generally related to a game, and more specifically a game surface employing game pieces for use in gaming.

### BACKGROUND

Traditional Craps is a popular game that uses two gravity centered, machine polished dice, where each die has six surfaces labeled one through six via a respective number of dots. When the dice are “tossed,” by a player or (also referred to as a “shooter”) there are thirty-six possible combinations that result in a “roll” which ultimately determines if all of the players' bets are won or lost. For example, a single roll may win some bets, lose some bets, and not affect other bets. In contrast to other games such as black jack which have outcomes determined by cards dealt by a dealer, in craps the result of the game is primarily based on random outcome of the dice.

However, one disadvantage to the game of craps (from the casino perspective) is that sophisticated craps players understand the true odds of most bets that can be placed during a craps game. As such, these players typically only place bets on those that have the lowest house edge and seek craps tables with wagering opportunities, such as 10× odds bets. These advantageous wagering opportunities, however, further decrease the already thin house advantage of the host casino and provide a need for a new game with greater entertainment.

Accordingly, one of the objects of the present invention to provide a game that offers a “roll” based on a game cube and cards for greater entertainment.

### SUMMARY

Various methods for offering a “roll” can be incorporated into a craps game or other games that traditionally use dice as a method of determining play outcome. In one embodiment, a method for playing a game on a game surface is disclosed. The method includes mixing a predetermined set of playing cards, placing each of the cards in the set face down into respective coded areas on the game surface, and determining one or more codes appearing face up on a plurality of coded game pieces based on a roll of the plurality of coded game pieces on the game surface. The method further includes determining a result of the roll by revealing a subset of the set of cards in the plurality of coded areas based on the one or more codes appearing face up on the plurality of coded game pieces.

Another embodiment includes an apparatus comprising a gaming surface, disposed on a support member such as a table or as an electronic display with a plurality of coded areas, each coded area configured to receive a card selected from a predetermined set of cards where each card has an assigned numerical value>0. The gaming surface is configured to receive a roll of a plurality of coded game pieces, each coded game piece having a plurality of sides, each side having an indicator corresponding to a coded area in the plurality of coded areas of the gaming surface, and the gaming surface is further configured to present a result of the roll based on identifying one or more cards corresponding to one or more indicators appearing face up on the plurality of coded game pieces. The embodiment may further include an apparatus where the card is received at the coded area oriented face down and where one or more cards are identified by orienting the one or more playing cards face up. In an embodiment the cards can be oriented face up prior to the game surface presenting the result of a roll. In an embodiment the cards can be oriented face up after the game surface presents the result of a roll. The embodiment may further include where each card is assigned a different value than the other cards in the predetermined set of cards, for example the value can be selected from the group consisting of 1, 2, 3, 4, 5, and 6. The embodiment may further include coded game pieces which are a pair of cubes. Further, the indicator present on each face of the game cube may be a predetermined color or a single dot of a predetermined color. The embodiment may also include where result of the roll is determined based on a value of the one or more playing cards.

Another embodiment includes a system comprising a gaming surface having a plurality of coded areas, each coded area configured to receive a card selected from a predetermined set of cards each card having an assigned numerical value>0 and a plurality of coded game pieces, each coded game piece having a plurality of sides, each side having an indicator corresponding to a coded area in the plurality of coded areas of the gaming surface. The gaming surface is configured to present a result of a roll of the plurality of coded game pieces based on identifying one or more cards corresponding to one or more indicators appearing face up on the plurality of coded game pieces. The embodiment may further include a system where the card is received at the coded area oriented face down and where one or more cards are identified by orienting the one or more playing cards face up. In an embodiment the cards can be oriented face up prior to the game surface presenting the result of a roll. In an embodiment the cards can be oriented face up after the game surface presents the result of a roll. The embodiment may further include a system where each card is assigned a different value than the other cards in the predetermined set of cards, for example the value can be selected from the group consisting of 1, 2, 3, 4, 5, and 6. The embodiment may further include coded game pieces which are a pair of cubes. Further, the indicator present on each face of the game cube may be a predetermined color or a single dot of a predetermined color. The embodiment may also include where result of the roll is determined based on a value of the one or more playing cards.

Another embodiment includes an electronic gaming apparatus that includes a processor, a display, controlled by the processor and configured to display an electronic gaming surface having a plurality of coded areas, each coded area configured to receive a card selected from a predetermined set of cards each card having an assigned numerical value>0, and a plurality of coded game pieces, each coded game piece having a plurality of sides, each side having an indicator corresponding to a coded area in the plurality of coded areas of the electronic gaming surface, where the electronic gaming surface is configured to present a result of a roll of the plurality of coded game pieces based on identifying one or more playing cards corresponding to one or more indicators appearing face up on the plurality of coded game pieces. The embodiment may further include an electronic gaming apparatus where the card is received at the coded area oriented face down and where one or more cards are identified by orienting the one or more playing cards face up. In an embodiment the cards can be oriented face up prior to the game surface presenting the result of a roll. In an embodiment the cards can be oriented face up after the game surface presents the result of a roll. The embodiment may further include an electronic gaming apparatus where each card is assigned a different value than the other cards in the predetermined set of cards, for example the value can be selected from the group consisting of 1, 2, 3, 4, 5, and 6. The embodiment may further include coded game pieces which are a pair of cubes. Further, the indicator present on each face of the game cube may be a predetermined color or a single dot of a predetermined color. The embodiment may also include where result of the roll is determined based on a value of the one or more playing cards. Further, the embodiment may be an electronic gaming apparatus that is a slot machine.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1A is a schematic diagram illustrating an embodiment of a game surface layout.

FIG. 1B is a schematic diagram illustrating an embodiment of colored boxes of FIG. 1A in more detail.

FIG. 2 is a schematic diagram illustrating an embodiment of a color scheme for labeling the sides of each game piece.

FIG. 3 is a schematic diagram illustrating a perspective view of a pair of color coded game pieces in accordance with an embodiment.

FIG. 4 is a flow chart illustrating an embodiment of a method for playing a table game.

FIG. 5 is a flow chart illustrating an embodiment of a method for playing a table game.

FIG. 6 is a schematic diagram illustrating an embodiment of a computer architecture in accordance with an embodiment.

FIG. 7 is side perspective view of a poker table of the type to facilitate play according to embodiments of the present invention.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here. One skilled in the art recognizes that numerous alternative components and embodiments may be substituted for the particular examples described herein and still fall within the scope of the invention.

An embodiment of the present game incorporates colored boxes on a Craps-like game surface layout, playing cards Ace through Six (6), and two cubes with an indicator or symbol on each cube face corresponding to an indicator or symbol in the boxes on the game surface layout. Instead of using dice to determine the roll, an embodiment of the present game employs cubes and playing cards for roll determination.

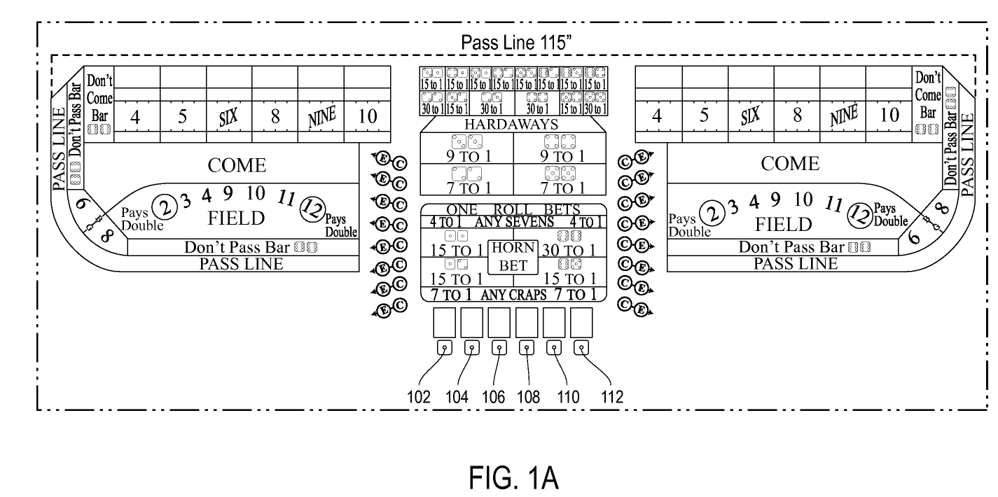

With reference to FIGS. 1A-1B, the game surface layout 100 has six different colored boxes—Red 102, Blue 104, Orange 106, Green 108, Black 110, and Yellow 112—directly in front of the Stick person position in the center of the table. In an embodiment, the table may be a physical game table described in more detail below or a virtual game table surface presented via a graphical user interface displayed via an electronic gaming device. Such electronic gaming device may be a portable gaming device or an electronic gaming terminal that is part of a casino gaming network for example. These electronic gaming devices are known in the art and do not require further description. In the virtual game table surface user interfaces are incorporated into the display which are configured to allow a player or players to place a bet, roll game cubes or perform other actions required of the player by the game.

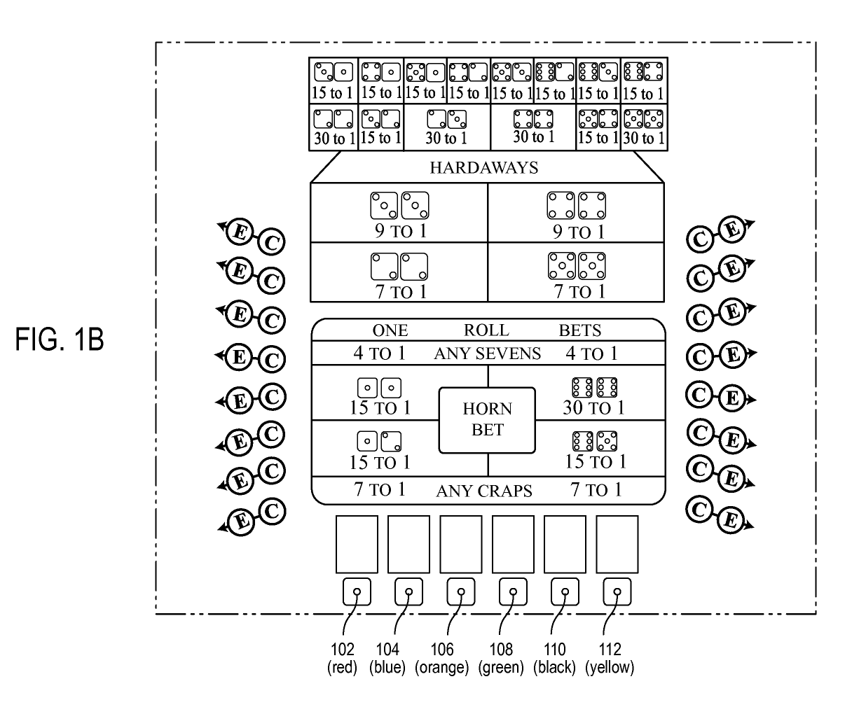

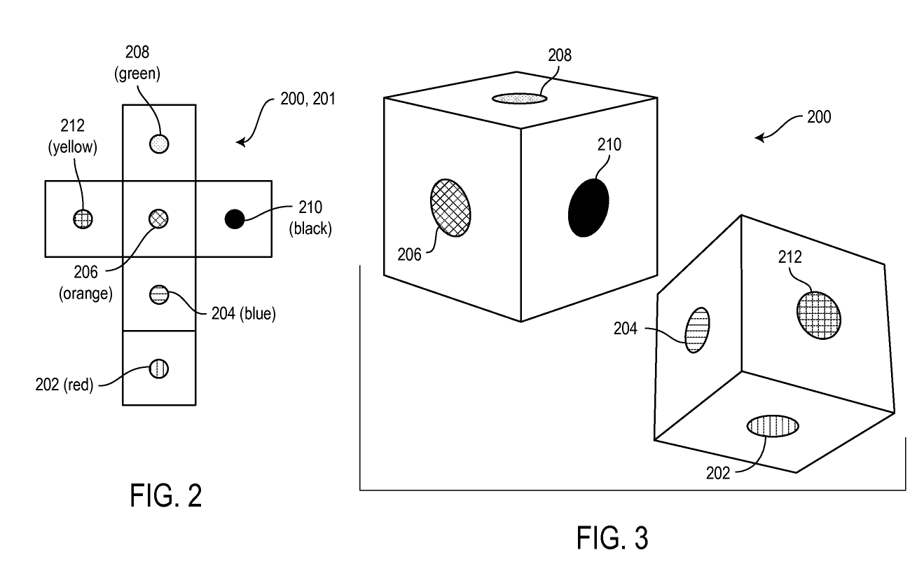

The game surface includes six boxes where playing cards Ace, Two, Three, Four, Five and Six are randomly placed face down by the dealer in each of the six boxes 102-112. In an embodiment, the Ace card corresponds to rolling a value of “one” via a game cube when an indicator on the box having the Ace card is selected based on a corresponding indicator being rolled via one or both game cubes 200, 201 (discussed in FIGS. 2-3 below). The remaining playing cards Two, Three, Four, Five, and Six similarly correspond to rolling respective numbers based on matching indicator rolled via the game pieces 200, 201 with respective boxes 102-112. In this embodiment, the indicator associated with the box and the game cube is a colored dot.

As shown in FIGS. 2-3, an embodiment of the game utilizes two six-sided cubes 200, 201. In an embodiment, each cube is machine calibrated, gravity centered and includes a different single colored dot (pip) 202-212 on each side corresponding to the respectively colored boxes 102-112 on the layout 100. In particular, each side of the six-sided cubes 200, 201 includes a Red dot 202 corresponding to Red box 102, a Blue dot 204 corresponding to a Blue box 104, an Orange dot 206 corresponding to the Orange box 106, a Green dot 208 corresponding to a Green box 108, a Black dot 210 corresponding to a Black box 110, and a Yellow dot 212 corresponding to a Yellow box 112. The two cubes 200, 201 are rolled and the playing card in the colored box corresponding to the color of the dot face up is turned over, thus determining the roll. If the same color is face up on both cubes 200, 201, then the roll is considered a hardway. For example, if two yellows are rolled and the card number in the yellow box is Two, then the roll is a hard four (i.e., a pair of twos).

While the foregoing embodiments discuss game pieces color-coded with dots, as well as a game surface having corresponding color boxes, those skilled in the art will realize that other coding schemes are within the scope of the invention, including without limitation using game pieces where an indicator is represented with differently colored sides and/or having coded symbols or shapes other than dots and a game surface having boxes corresponding to the indicator, coded symbol or shape on the game piece. Alternatively or in addition, additional embodiments may include randomly re-arranging the colored boxes on the game surface after the playing cards have been randomly placed face down in each box so as to further randomize the cards. In embodiments, the color boxes may be rearranged either by randomly swapping their respective positions on the game surface or by randomly assigning different color lighting to stationary boxes 102-112.

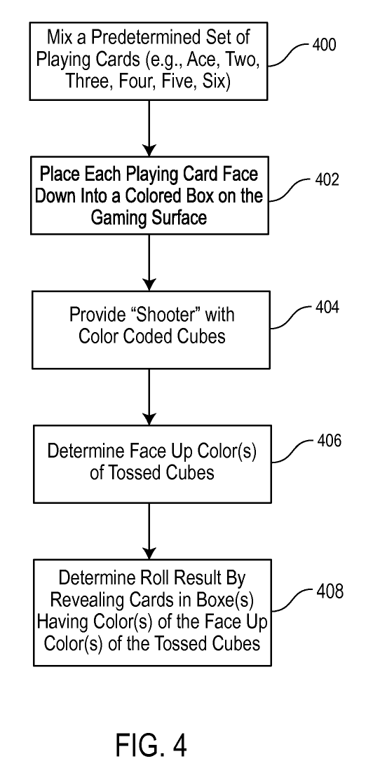

Referring to FIG. 4, an embodiment of a method for playing a game is shown. In steps 400-402, the dealer (in an embodiment, a gaming server) mixes the six cards (e.g., Ace, Two, Three, Four, Five and Six) face down on the layout 100 and places one card in each of the six colored boxes 102-112. In step 404, the cubes 200, 201 are delivered or otherwise presented to the “shooter” game participant. In steps 406-408, the cubes 200, 201 are then tossed by the “shooter” and the face up colors of the cubes determine which of the six cards in the corresponding colored boxes 102-112 on the layout 100 are turned over to reveal the value of card, thus creating a “roll.” Once the “roll” is completed, bets are settled, additional bets made and the game continues with the dealer mixing the cards, placing each card in a colored box 102-112 and the cubes 200, 201 are passed to the “shooter” for the next “roll.” One advantage of this method is that any knowledge of the true odds of most bets that can be placed during a craps game using traditional dice are eliminated. For example, unlike traditional dice, when the “shooter” uses cubes the resulting “roll” is not known until the corresponding card value is revealed. Accordingly, the players will not know what color(s) correspond to snake eyes, e.g. a pair of Aces or boxcars e.g. a pair of sixes until the dealer reveals the card value associated with the roll of the game cube. Moreover, in an embodiment where the cards are shuffled or mixed in-between each “roll” the value of a particular color on a game cube is ever changing depending on the shuffle and resulting placement of the cards in each respective colored box.

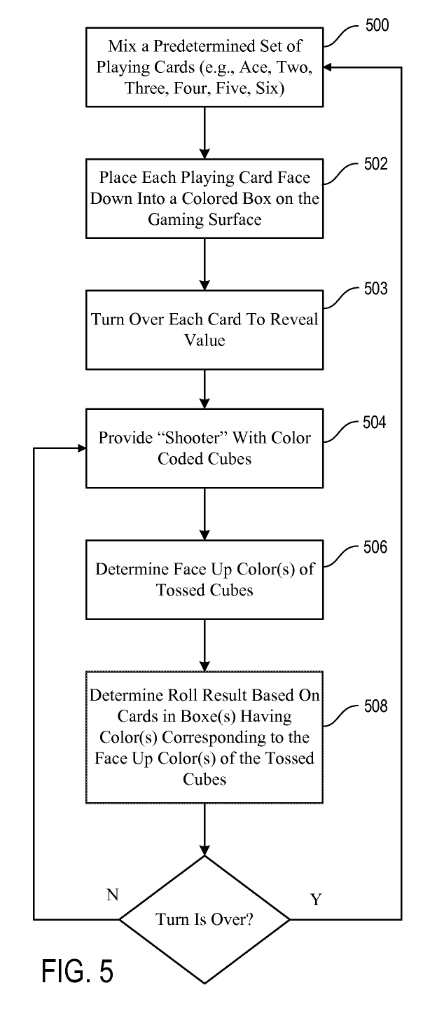

Referring to FIG. 5, another embodiment of a method for playing the game is shown. In steps 500-502, the dealer (in an embodiment, a gaming server) mixes the six cards (e.g., Ace, Two, Three, Four, Five and Six) face down on the layout 100 and places one card in each of the six colored boxes 102-112. In step 503 the cards are turned over to reveal the value of each card. In step 504, the cubes 200, 201 are delivered or otherwise presented to the “shooter” game participant. In steps 506-508, the cubes 200, 201 are then tossed by the “shooter” and the face up colors of the cubes determine which of the six cards in the corresponding colored boxes 102-112 on the layout 100 create a “roll.” The cards remain face up in the colored boxes until that particular roll concludes e.g. a seven is rolled after the point had been established. Once the “roll” is completed, bets are settled, additional bets made and the game continues with the dealer mixing the cards, placing each card in a colored box 102-112 and the cubes 200, 201 are passed to the “shooter” for the next “roll.” One advantage of this method is that the players know what color(s) correspond to snake eyes, e.g. a pair of Aces or boxcars e.g. a pair of sixes when the cubes are delivered to the “shooter” participant. This method of play can improve game efficiency by increasing the number of rolls per hour. However, in this embodiment the cards are shuffled or mixed in-between each “roll” so that the value of a particular a color on a game cube is ever changing depending on the shuffle and resulting placement of the cards in each respective colored box.

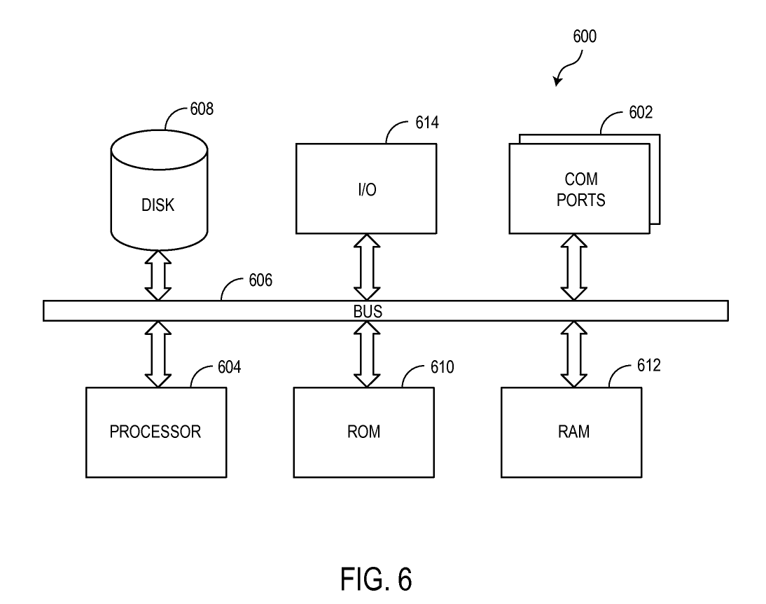

Referring to FIG. 6, an embodiment of a computer architecture which performs the present teachings, including the elements executing computer readable code associated with the steps of FIGS. 4 and 5, is shown. For example, the computer 600 can be a special purpose computer, such as a gaming server, executing the components of the gaming system described herein, including via hardware, software program, firmware, or a combination thereof. In embodiments, the computer processing functions relating to the gaming functionality described in FIGS. 1-5 above may be implemented in a distributed fashion on a number of computing devices, so as to distribute the processing load. Further, in an embodiment the computer processing functions relating to the gaming functionality described in FIGS. 1-5 can be implemented into various electronic devices such as an electronic table, a slot machine, a mobile phone, a tablet or the like.

The computer 600, such as a gaming server or a gaming user device, includes COM ports 602 connected to an electronic data communication network (e.g., a LAN, WAN, Internet, or the like) to facilitate data communications. The computer 600 further includes a processor, such as a central processing unit (CPU) 504, which executes program instructions comprising the steps of FIG. 4, FIG. 5, or both. The depicted computer platform includes bus 606, as well as non-transitory computer readable media having stored thereon computer executable instructions including those of FIG. 4, FIG. 5, or both. Such computer readable media and data storage includes, for example, hard disk drive 608, read only memory (ROM) 610, and random access memory (RAM) 612. The computer 600 further includes an I/O module 614, supporting input/output flows between respective computer components, such as user interface elements 616. The computer 600 is configured to receive programming and data via the data communication network.

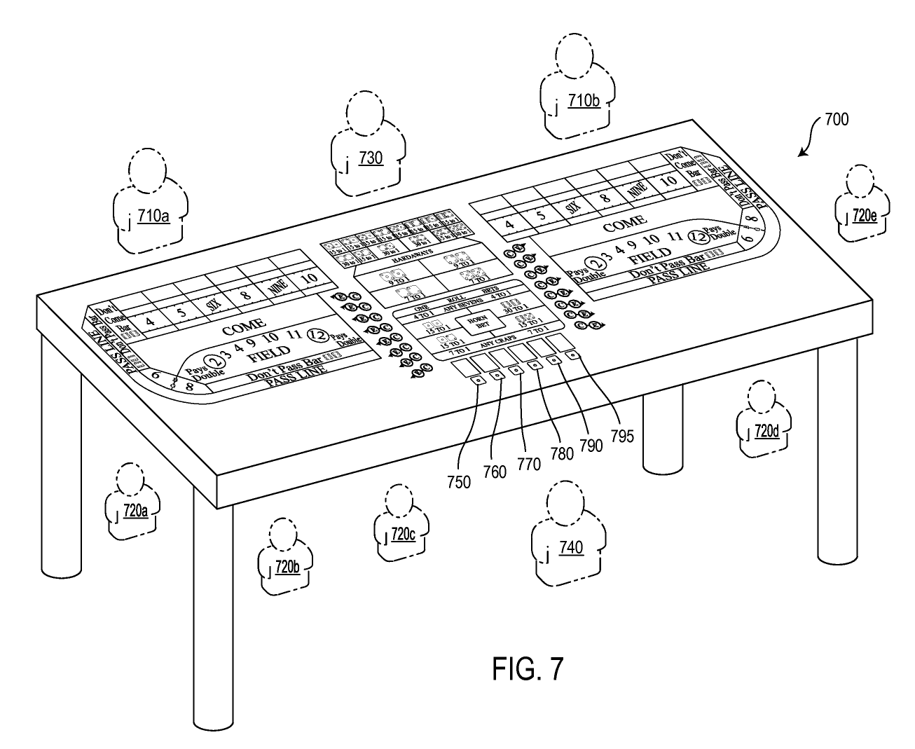

Referring to FIG. 7, which shows a physical table 700 that may be used to facilitate a game according to embodiments of the present invention. As shown, the table 700 is rectangular in shape, but those of skill in the art will recognize that other shapes are possible (e.g. square, circular, and elliptical). The table 700 incorporates a pair of dealer stations 710-a and 710-b and accommodates up to 15 players at player stations. The embodiment in FIG. 7 shows five players 720a-e, but more or less players may be accommodated by the table 700. Depending on the embodiment, each dealer station 710-a and 710-b may include at least one of an automatic card shuffler, chip rack and drop box. The table 700 also includes a box person station 730 who oversees game play, settles disputes, and/or counts bets. The table 700 also includes a stickperson position 740 who uses a stick to present the game cube to a player and may place bets on an area on the table for players.

The table 700 includes a layout with six different boxes a first box 750, a second box 760, a third box 770, a fourth box 780, a fifth box 790, and a sixth box 795—directly in front of the Stick person position 740 in the center of the table. Playing cards Ace, Two, Three, Four, Five and Six are also used and are randomly placed face down by the dealer in the each of the six boxes 760-795. In an embodiment, the Ace card corresponds to rolling a “one” via a game cube when a box having a symbol matching the Ace card is selected based on a corresponding symbol being rolled via one or both game cubes 200, 201 (discussed in FIGS. 2-3 above). The remaining playing cards Two, Three, Four, Five, and Six similarly correspond to rolling respective numbers based on matching symbol rolled via the game pieces 200, 201 with respective boxes 760-795.

Those skilled in the art will realize that various coding schemes are within the scope of the invention and can be used for the game cube and boxes on the table, including without limitation using game pieces where an indicator is represented with differently colored sides and/or having coded symbols or shapes other than dots and a game surface having boxes corresponding to the indicator, coded symbol or shape on the game piece. Alternatively or in addition, additional embodiments may include randomly re-arranging the colored boxes on the game surface after the playing cards have been randomly placed face down in each box so as to further randomize the cards. In embodiments, the color boxes may be rearranged either by randomly swapping their respective positions on the game surface or by randomly assigning different color lighting to stationary boxes 750-795.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
providing a support member and a gaming surface disposed on the support member, the gaming surface having a plurality of uniquely coded areas, each coded area configured to receive a card selected from a predetermined set of playing cards, each card having an assigned numerical value>0,
mixing the predetermined set of playing cards;
placing each of the playing cards of the set face down on its respective coded areas on the gaming surface;
receiving a roll of a plurality of coded game pieces, each coded game piece having a plurality of sides, each side of each coded game piece having an indicator corresponding to a respective coded area of the plurality of coded areas of the gaming surface, each coded game piece configured to have one of its sides presented face up after the roll, and
determining a result of the roll by the numerical values of one or more of the playing cards corresponding to the indicators appearing on the face up sides of the plurality of coded game pieces.

2. The method of claim 1, wherein the playing cards are placed face down on the gaming surface.

3. The method of claim 2, wherein the step of determining the result of the roll includes flipping over those playing cards corresponding to the face-up sides of the coded game pieces.

3. The method of claim 1, wherein each playing card is received at its coded area oriented face down.

4. The method of claim 1, wherein the gaming surface informs as to odds of different combinations of coded game piece indicators appearing face up after the roll.

5. The method of claim 1, wherein the gaming surface includes identifiable areas on which bets can be received.

6. The method of claim 1, wherein each coded game piece is a cube.

7. The method of claim 1, wherein each indicator of each coded game piece has a unique predetermined color.

8. The method of claim 7, wherein each indicator of each coded game piece is a colored dot.

9. The method of claim 1, wherein the gaming surface has six coded areas and each playing card in the predetermined set of playing cards has a value selected from the group consisting of the numerical values 1, 2, 3, 4, 5, and 6.

10. The method of claim 9, wherein each playing card has a unique numerical value.

11. The method of claim 1, wherein each coded area is coded by a unique color.

12. The method of claim 1 wherein the gaming surface is an electronic display.

13. A method comprising:
providing a gaming surface having a plurality of uniquely coded areas, each coded area configured to receive a card selected from a predetermined set of cards, each card having an assigned numerical value>0; and
providing a plurality of coded game pieces, each coded game piece having a plurality of sides, each side of each coded game piece having an indicator corresponding to a respective coded area of the plurality of coded areas of the gaming surface, each coded game piece configured to have one of its sides presented face up after a roll of the coded game pieces,
receiving the cards on the uniquely coded areas;
receiving the roll of the plurality of coded game pieces, and
determining a result of the roll by matching the numerical values of one or more of the cards corresponding to the indicators appearing on the face up sides of the plurality of coded game pieces.

14. The method of claim 13, wherein each card is received at its coded area oriented face down.

15. The method of claim 14, wherein the one or more cards are identified by re-orienting the one or more cards face up.

16. The method of claim 13, wherein the one or more cards are identified by re-orienting the one or more cards face up before the gaming surface receives the roll of the plurality of coded game pieces.

17. The method of claim 13, wherein each coded game piece is a cube.

18. The method of claim 13, wherein each indicator is a uniquely colored dot.

19. The method of claim 13, wherein teach coded area is coded by a unique color.

20. The method of claim 13 wherein the gaming surface is an electronic display.

21. A method comprising:
providing a computerized apparatus with a display;
energizing the computerized apparatus; and
allowing the computerized apparatus to execute computer readable instructions and to:
provide a gaming surface graphic on the display, the gaming surface graphic having a plurality of uniquely coded areas, each coded area configured to receive a virtual playing card selected from a predetermined set of virtual playing cards, each virtual playing card having an assigned numerical value>0,
mix the predetermined set of virtual playing cards;
virtually place each of the virtual playing cards of the set face down on its respective coded areas on the gaming surface;
effect a roll of a plurality of virtual coded game pieces, each virtual coded game piece having a plurality of sides, each side of each virtual coded game piece having an indicator corresponding to a respective coded area of the plurality of coded areas of the gaming surface graphic, each virtual coded game piece configured to have one of its sides presented face up after the roll, and
determine a result of the roll by the numerical values of one or more of the virtual playing cards corresponding to the indicators appearing on the face up sides of the plurality of virtual coded game pieces.

22. The method of claim 21, wherein the virtual playing cards are virtually placed face down on the gaming surface graphic.

23. The method of claim 22, wherein the step of determining the result of the roll includes flipping over those virtual playing cards corresponding to the face-up sides of the virtual coded game pieces.

24. The method of claim 21, wherein each virtual playing card is received at its coded area oriented face down.

25. The method of claim 21, wherein the gaming surface graphic informs as to odds of different combinations of game piece indicators appearing face up after the roll.

26. The method of claim 21, wherein each virtual coded game piece is a virtual cube.

27. The method of claim 21, wherein each indicator of each game piece has a unique predetermined color.

28. The method of claim 27, wherein each indicator of each game piece is a colored dot.

29. The method of claim 21, wherein the gaming surface graphic has six coded areas and each virtual playing card in the predetermined set of cards has a value selected from the group consisting of the numerical values 1, 2, 3, 4, 5, and 6.

30. The method of claim 29, wherein each virtual playing card has a unique numerical value.
